(19) United States
(12) Patent Application Publication
(10) Pub. No.: US 2005/0136389 A1
(43) Pub. Date: Jun. 23, 2005

(54) Write-on wipe-off book cover

(76) Inventor: Barbara A. Galbraith Coates, West Paterson, NJ (US)

Correspondence Address: BARBARA GALBRAITH COATES, 9 HARRISON COURT, WEST PATERSON, NJ, 07424, US

(21) Appl. No.: 10/737,829

(22) Filed: Dec. 18, 2003

(51) Int. Cl. B43L 1/00

(52) U.S. Cl. 434/408

(57) ABSTRACT

An educational device that makes any existing printed material, such as a child's open workbook, reusable. Children view their work through the clear transparent cover of the apparatus and record answers using a dry erase marker or similar writing instrument. When completed, answers easily wipe away using a damp cloth, allowing for exercises to be repeated many times until mastery. Additionally, original workbook, original worksheet, or original printed matter remain protected and in tact.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

The present invention relates generally to educational devices, specifically to an apparatus used in conjunction with any ordinary school workbook, which will allow children, especially young children, children with learning disabilities and children with limited writing and fine motor skills, to practice a wide range of learning skills in any subject in a way that promotes a sense of self-confidence and pride. In addition, the write-on wipe-off book cover can also be used for more recreational activities including, but not limited to, coloring and games.

The write-on wipe-off book cover was invented out of a necessity. My child needed to be able to practice schoolwork several times before mastery. Many children need to repeat exercises many times in order to acquire a particular skill. When provided with unlimited opportunities to practice, children can and do learn.

Workbooks are well known in the educational field. A seemingly unlimited variety of workbooks have been developed to aid in teaching children mathematics, handwriting, language, science, social study, music, grammar, etc. Such workbooks are valuable instructional tools because they cover a wide range of learning skills, they provide a diversity of formats, and because exercises are typically sequenced from easiest to more difficult. Also, the exercises in typical school workbooks are generally enriched by fun drawings, colors, and interesting formats.

However, exercises in conventional workbooks that use a paper and pencil approach, can only be used once. There is only one chance to fill in each page and complete the assignment. There is no opportunity for repeated practice of any particular page. Making multiple copies of the same page from which to practice becomes impractical, costly, and in some cases, not an option due to copy written materials.

### BRIEF SUMMARY OF THE INVENTION

The present invention is a “hands-on”, extremely simple, reusable educational device for children, especially for young children, children with learning disabilities, and children with limited proficiency in writing and/or workbook skills. It assists children in a wide range of academic skills when used in conjunction with any printed matter such as a child's workbook or worksheet. It is a cost effective, timesaving tool that allows an instructor or teacher to use the same printed material many times over, either with the same student or with many different students.

The write-on wipe-off book cover is an envelope or box like apparatus consisting of two primary components: a top surface of a clear transparent material, and a flat hard supporting back surface. Any printed matter such as an opened child's workbook, can be inserted and easily viewed between the two surfaces of the invention. As a result, the present invention has several objectives and advantages:

One objective of the invention is to allow students to record their answers on the clear transparent surface cover of the apparatus using a dry erase or similar marker. This provides students who have limited writing skills and/or limited fine motor control an easier and more successful method of recording their answers since less fine motor skill and/or coordination is required than with traditional paper and pencil. And, some children prefer using markers of different colors rather than a pencil. By allowing the use of color, children may find the learning experience to be more satisfying than traditional pencil and paper, which may motivate them to spend more time practicing with their schoolwork.

It is another objective of the invention, used in conjunction with any printed matter such as a child's workbook or worksheet, to provide an educational device that make virtually any existing workbook reusable. After the student records his or her answers on the clear transparent surface cover of the apparatus using a dry eraser or similar marker, all the answers can be easily wiped away using a damp cloth. This permits repeated use of the same workbook page, and additionally, the original workbook, original worksheet, or original printed matter remain protected and in tact.

It is another objective of the invention to allow for workbook related activities to be repeated many times until mastery. Through the use of this invention, in conjunction with any children's workbook, a child has the means to practice the same activities on a particular page over and over again until the targeted skill is mastered. Practice facilitates learning and skill mastery.

It is yet another objective of the invention to provide a time-saving, cost effective educational device which permits home-schoolers and teachers, either with the same student or with many different students, the ability to use the same printed matter, such as children's workbooks and worksheets, many times over without having to purchase multiple copies of the same printed materials. There are potential cost savings that can be realized by not having to purchase multiple workbooks if one copy can be purchased and reused many times by the same student or with many different students.

Further objectives and advantages of the invention are to provide an educational device, which is economical and simple to produce, highly effective in its utility, easy to use by children, and indefinitely reusable. Each of these objectives will be apparent from the description herein.

In accordance with certain of its aspects, this invention relates to a reusable educational device for children, especially for young children, children with learning disabilities, and children with limited proficiency in the language of instruction to practice a particular subject in conjunction with any existing workbook comprising:

An envelope or box like device having a top and bottom surface, said top surface comprising of a clear transparent material, and said back surface comprising of a flat hard supporting surface, wherein said top and bottom surfaces are of the same oblong size and connected together on at least one of four sides. At least one side remains open or unconnected allowing for insertion of any existing printed matter such as a child's opened workbook. While the invention is illustrated and described in a preferred embodiment, the device may be produced in different sizes, configurations, forms, and materials.

### BRIEF DESCRIPTION OF THE SEVERAL VIEWS OF THE DRAWING

The present invention may best be understood with reference to the following description, taken in connection with the accompanying drawings. While the invention is illustrated and described in a preferred embodiment in FIGS. 1, 1A, and 2, the device may be produced in different sizes, configuration, forms and materials. One such alternative form is illustrated in FIG. 3 and FIG. 4.

FIG. 1 illustrates the write-on wipe-off book cover in full view in a preferred embodiment, as an envelop-like apparatus

FIG. 1A is a partial enlarged sectional side view of the layers comprising the write-on wipe-off book cover, as an envelop-like apparatus

FIG. 2 depicts the write-on wipe-off book cover in use with an opened workbook inserted into said invention

FIG. 3 illustrates an alternative form of the write-on wipe-off book cover as a box-like apparatus in the closed position

FIG. 4 illustrates an alternative form of the write-on wipe-off book cover as a box-like apparatus in the open position

### DETAILED DESCRIPTION OF THE INVENTION

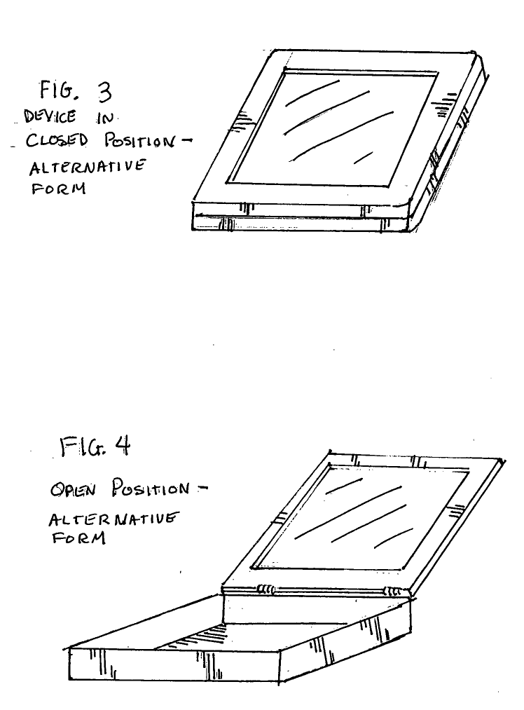

Referring to FIG. 1, the write-on wipe-off book cover is a rectangular shaped, envelope-like device that can be used with any standard sized workbook, worksheet or printed matter. It is large enough to hold a standard sized workbook in the open position. While the invention is illustrated and described in a preferred embodiment, the device may be produced in different sizes, configuration, forms and materials. One such alternative is shown in FIG. 3 and FIG. 4.

Referring to FIG 1A, the write-on wipe-off book cover is comprised of a top and bottom layer. The top layer is a single clear layer of pliable vinyl while the bottom layer is a fabric-covered board. The fabric-covered board can be of any flat supporting material.

Both the top and bottom layer are attached together on three sides. Attachment can be with adhesive glue, or with thread (i.e., machine stitched). The fourth longer side remains open. This open side of the present invention allows for the insertion of any existing printed matter such as a child's open workbook.

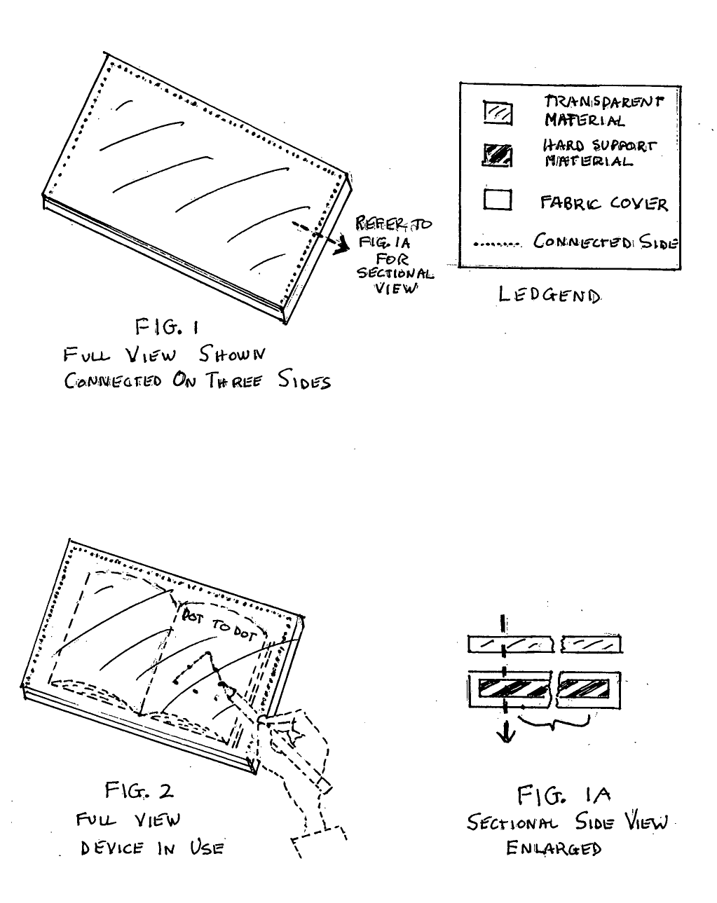

As illustrated in FIG. 2, once the printed matter is inserted, the device is ready for use and children can simply record their answers by writing on the clear transparent top side of the present invention utilizing any dry erase marker or similar writing instrument.

When done, the student is able to wipe the clear transparent top cover clean using a dampened paper towel or cloth. The write-on wipe-off book cover is ready to use over and over again. The original printed matter (i.e. worksheet or book) remains protected and in tact.

It is apparent to those skilled in the art that the write-on wipe-off book cover can be further adapted within the scope of the invention.

1. A reusable write-on wipe-off book holder for teaching children, comprising of:
a top cover surface having four edges and being of a clear transparent material able to accept dry-erase markings, wipe-off crayon markings, and like markings thereon and erasure therefrom;
and a bottom rigid flat supporting surface, being a fabric encased board;
wherein said top and bottom surfaces are of approximately the same shape and size and connected together on three sides by means of machine stitching creating one unattached open side;
whereby said open side allows for insertion of printed mater in the form of a child's workbook in the open reading position being of any length and of any width up to the fixed length and fixed width of said top cover surface and said workbook being of varying thickness;
whereby said top cover, being formed of a material such that it may be flexible enough to accommodate a variety of workbooks of varying thickness in the open reading position, and said top cover surface being formed of clear transparent pliable vinyl, and said vinyl being able to accept dry erase markings or wipe-off crayon markings thereon and erasure therefrom;
whereby said printed matter in the form of a child's workbook in the open reading position, or the like is viewed through said top transparent cover surface and answers are recorded on said top transparent cover surface.
